(19) United States
(12) Patent Application Publication
(10) Pub. No.: US 2013/0031537 A1
(43) Pub. Date: Jan. 31, 2013

(54) Specialized Function Implementation Using Code Frequency Profiling

(71) Applicants: Omer Yehuda Boehm, Haifa (IL); Gad Haber, Nesher (IL); Yousef Shajrawi, Natzrat (IL)

(72) Inventors: Omer Yehuda Boehm, Haifa (IL); Gad Haber, Nesher (IL); Yousef Shajrawi, Natzrat (IL)

(73) Assignee: International Business Machines Corporation, Armonk, NY (US)

(21) Appl. No.: 13/192,484

(22) Filed: Jul. 28, 2011

(51) Int. Cl. G06F 9/45

(52) U.S. Cl. 717/154

(57) ABSTRACT

Systems, methods and products for code optimization are provided. In one embodiment, the method comprises dividing a target code into basic blocks; analyzing traversed execution paths between the basic blocks during multiple executions of the target code to determine a frequency with which the execution path between two or more basic blocks are traversed; and determining whether code optimization may be achieved by identifying execution paths that have been traversed subject to one or more threshold levels.

### COPYRIGHT & TRADEMARK NOTICES

A portion of the disclosure of this patent document may contain material subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to optimizing execution of program code in a computing environment and, more particularly, to a system and method for implementing specialized functions based on a code frequency profiling scheme.

### BACKGROUND

Code optimization enables better utilization of a computing system's resources and improves the execution time of program code running on the computing system. Function specialization is an optimization method used in profile driven compilers and optimizers in which the body of a function in the program code is cloned and then optimized based on profile information gathered during the execution of the same code.

In a value-based function optimization, the goal is to optimize the code in a function block by determining whether conditional branching that depends on the value of one or more function parameters (e.g., a target variable ‘x’) can be optimized by using a specialized function, when a certain condition or set of conditions are met. Since the satisfaction of such conditions is based on the value of ‘x’, it would be helpful to know the most common value assigned to ‘x’ when the function is called in order to optimize the code using a specialized function implemented based on said most common value.

While value profiling is the known technique for determining the frequent parameter values that are used when a function is called, the process is associated with substantial overhead. This is because it generally requires a special profiling phase in which common values of the target parameters are collected during code execution or a test run for some representative workload. FIG. 1 provides an example of a function foo(x) for which a specialized version is implemented based on value profiling results indicating that the most frequent value assigned to ‘x’ at time function foo(x) is called is 20.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for code optimization is provided. In one embodiment, the method comprises dividing a target code into basic blocks; analyzing traversed execution paths between the basic blocks during multiple executions of the target code to determine a frequency with which the execution path between two or more basic blocks are traversed; and determining whether code optimization may be achieved by identifying execution paths that have been traversed subject to one or more threshold levels.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an example code optimization scenario in which a specialized function is implemented based on value profiling of the parameter ‘x’ in function foo(x).

FIG. 2 illustrates an example code optimization scenario in accordance with one or more embodiments wherein a specialized function is implemented based on edge profiling results obtained for the program code for function foo(x).

FIG. 3 is a flow diagram of an exemplary method for optimizing program code using function specialization in accordance with one embodiment.

FIGS. 4A and 4B are block diagrams of hardware and software environments in which the disclosed systems and methods may operate, in accordance with one or more embodiments.

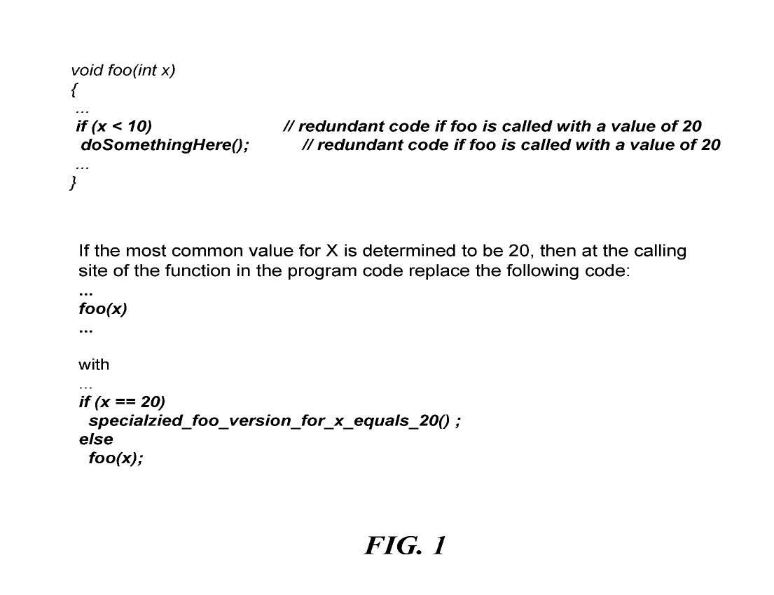

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one or more embodiments, to avoid the overhead associated with the traditional value profiling schemes, a lower-cost profiling method is utilized that is based on results obtained from analyzing the frequency of execution of certain code segments or code blocks. We refer to this low-cost profiling method generally as a code frequency profiling scheme and more specifically as edge profiling.

In edge profiling, the program code is divided into smaller code sections referred to here as basic blocks. The program execution flows between these basic blocks. A basic block may end with a branching instruction (e.g., a decision point based on one or more conditions). Otherwise the execution flows to the subsequent basic block. A control transfer between two basic blocks (e.g., due to a branching instruction or otherwise) is referred to here as a flow edge. During the edge profiling phase, data about the number of times a basic block is executed as well as the number of times each flow edge is taken is gathered and analyzed.

Without limitation, the result of the edge profiling in certain embodiments may be provided in the form of a graph of connected nodes in which a node represents a basic block and an edge from one node to another represents a path of execution from one basic block to another. The most frequently traversed edges (i.e., hot edges) are then analyzed to determine whether code optimization may be achieved by way of function specialization, in one or more embodiments.

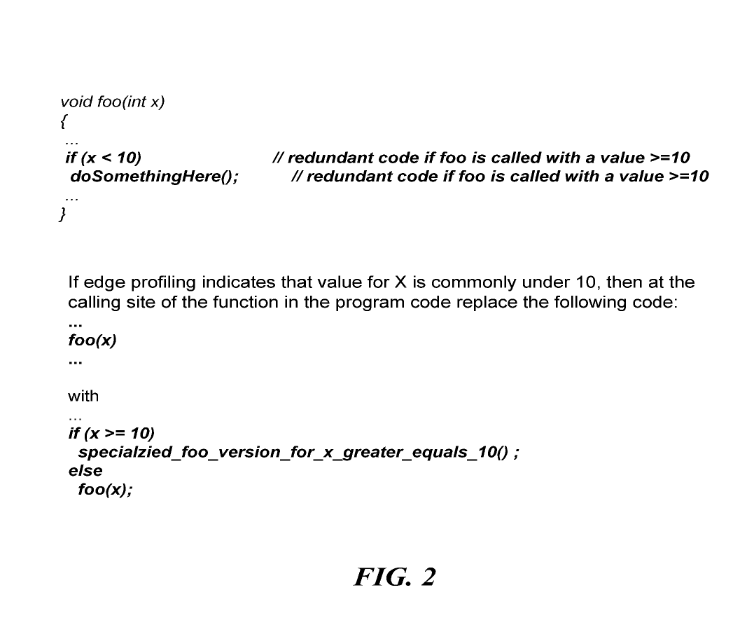

Referring to FIG. 2, an example function foo(x) is provided for which a specialized version is implemented based on an edge profiling scheme. In this example, the profiling results (not shown) may indicate that the most frequently traveled edge in the function code represents that the value assigned to ‘x’ at the time function foo(x) is called is frequently a value greater than or equal to 10, for example. Accordingly, given the target function foo(x), the edge profiling information about the frequency of statements executed in foo(x) is used to eliminate dead code or conditional branching that are based on the value of the ‘x’ parameter.

Thus, in the above example, if the edge profiling results indicate that the condition “if (x<10)” is frequently checked when foo (x) is called, but the edge that corresponds to that condition being true is rarely taken, then it would be safe to deduce that code optimization may be achieved by implementing a specialized version of foo to be called, instead of foo(x), when the above condition is not true. As such, the code block that calls foo(x) is optimized to perform a check on the value of ‘x’ prior to calling foo(x). If value of ‘x’ is greater or equal to 10, then the specialized function is called.

The above implementation results in optimization of the code because a simple check on the value of the parameter ‘x’ allows for the elimination of the function call foo(x) that requires memory and register utilization for passing the value of variable ‘x’ to the function, and receiving the results calculated by the function when the function returns. In particular, if the code block in function foo(x) includes a calculation loop that requires a large number of iterations with complex calculations inside the loop that are based on the value of ‘x’, then eliminating such calculations would significantly help reduce the length of execution of the program code.

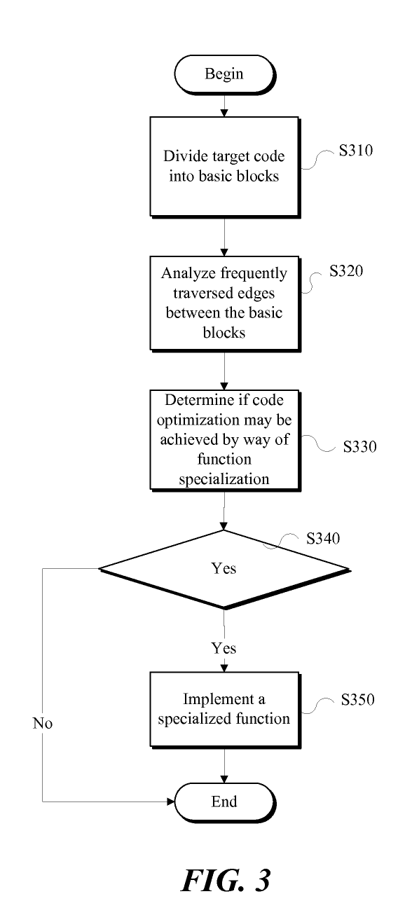

To recapitulate, and referring to FIG. 3, in accordance with one or more embodiments, a target code that is to be optimized is divided into basic blocks (S310). In one option, using a frequency profiling scheme, the target code is analyzed to determine the frequently traversed edges between the basic blocks during the code's execution (S320). Based on the result of the profiling, it is determined whether function specialization may be used to eliminate dead code from a target function or otherwise optimize the program code execution (S330). If so, then the specialized function is implemented so that it may be called instead of the target function when certain conditions are met (S340-S350).

As provided in the examples provided below, using the above method, a specialized function may be implemented based on determining a range of values for a target parameter, the exact value of which determines whether the specialized function is to be called instead of the original function. A range of values may be inferred from analyzing the frequency with which certain edges are traversed as the result of one or more conditions in the code because the satisfaction of said conditions is directly associated with the value of the target parameter at the time the target function is called.

Exemplary pseudo codes below help provide a better understanding of the concepts and methods disclosed above. It is noteworthy, however, that these examples are not to be construed as limiting the scope of the claimed subject matter to the specific details.

### Example A

```
#include <stdio.h>
#include <stdlib.h>
int foo(int x)
{
  int ret = 0;
  if (x == 0) {
    ret += 1;
  }
  if (x < 3) {
    ret += 3;
  }
  if (x < 7) {
    ret +=5;
  }
  if (x > 9) {
    ret += 7;
  }
  if (x < 13) {
    ret += 11;
  }
  return ret;
}
int main(int argc, char ** argv)
{
  int sum = 0;
  int n = 0;
  int i = 0;
  int x = 0;
  if (argc != 3) {
    return 1;
  }
  n = atoi(argv[1]);
  x = atoi(argv[2]);
  for (; i < n; ++i)
  {
    sum += foo(x);
  }
  printf(“%d\n”,sum);
  return 0;
}
```

The code in Example A above may be stored in a file called base.c, for example, and compiled based on the following script: xlc-o base base.c. Note that the code in Example A is not optimized. The following results indicate a total execution time of about 3 seconds.

| runs on a power6 machine: | |
|---|---|
| bash-3.00$ time ./base 100000000 10 | |
| 1800000000 | |
| real | 0m2.954s |
| user | 0m2.948s |
| sys | 0m0.002s |
| bash-3.00$ time ./base 100000000 and 10 | |
| 180,000,0000 | |
| real | 0m2.962s |
| user | 0m2.946s |
| sys | 0m0.002s |

A frequency profiling scheme may be applied to the code in Example A, in one embodiment. If the result of the frequency profiling indicates that the value of parameter ‘x’ when the function foo(x) is called commonly satisfies the conditions “x>9 and x<13” then the code in Example A may be optimized by way of using a specialized function as provided in Example B below.

### Example B

| | |
|---|---|
| #include <stdio.h> | |
| #include <stdlib.h> | |
| int foo(int x) | |
| { | |
| int ret = 0; | |
| if (x == 0) { | |
| ret += 1; | |
| } | |
| if (x < 3) { | |
| ret += 3; | |
| } | |
| if (x < 7) { | |
| ret +=5; | |
| } | |
| if (x > 9) { | |
| ret += 7; | |
| } | |
| if (x < 13) { | |
| ret += 11; | |
| } | |
| return ret; | |
| } | |
| int foo_gt_9_lw_13( ) | //Specialized Function// |
| { | |
| int ret = 0; | |
| ret +=7; | |
| ret += 11; | |
| return ret; | |
| } | |
| int main(int argc, char ** argv) | |
| { | |
| int sum = 0; | |
| int n = 0; | |
| int i = 0; | |
| int x = 0; | |
| if (argc != 3) { | |
| return 1; | |
| } | |
| n = atoi(argv[1]); | |
| x = atoi(argv[2]); | |
| for (; i < n; ++i) | |
| { | |
| if ((x > 9) && (x < 13)) { | |
| sum += foo_gt_9_lw_13( ); | //Call to Specialized Function// |
| } else { | |
| sum += foo(x); | //Call to Original Function// |
| } | |
| } | |
| printf(“%d\n”,sum); | |
| return 0; | |
| } | |

The code in Example B above may be stored in a file called opt.c, for example, and compiled based on the following script: xlc-o opt opt.c. Since the code in Example B is optimized, we have the following results which indicate a total execution time of less than 0.9 seconds, a substantial improvement over the 3-seconds execution time for the code in Example A.

| runs on a power6 machine: | |
|---|---|
| bash-3.00$ time ./opt 100000000 10 | |
| 1800000000 | |
| real | 0m0.897s |
| user | 0m0.888s |
| sys | 0m0.002s |
| bash-3.00$ time ./opt 100000000 10 | |
| 1800000000 | |
| real | 0m0.891s |
| user | 0m0.888s |
| sys | 0m0.002s |

As shown in Example C below, the optimized code in Example B may lead to further optimization by recognizing that the conditional code segment in the iterative loop in the main code is loop invariant and may be moved outside the loop. As shown, the loop invariant code segment which is hoisted out of the loop is executed less frequently and also allows for constant values to be stored in registers eliminating the need for calculating the respective addresses for accessing memory (or cache line) at each loop iteration.

### Example C

```
#include <stdio.h>
#include <stdlib.h>
int foo(int x)
{
  int ret = 0;
  if (x == 0) {
    ret += 1;
  }
  if (x < 3) {
    ret += 3;
  }
  if (x < 7) {
    ret +=5;
  }
  if (x > 9) {
    ret += 7;
  }
  if (x < 13) {
    ret += 11;
  }
  return ret;
}
int foo_gt_9_lw_13( )
{
  int ret = 0;
  ret +=7;
  ret += 11;
  return ret;
}
int main(int argc, char ** argv)
{
  int sum = 0;
  int n = 0;
  int i = 0;
  int x = 0;
  if (argc != 3) {
    return 1;
  }
  n = atoi(argv[1]);
  x = atoi(argv[2]);
  if ((x > 9) && (x < 13)) { //loop invariant code segment//
    for (; i < n; ++i)
    {
      sum += foo_gt_9_lw_13( );
    }
  } else {
    for (; i < n; ++i)
    {
      sum += foo(x);
    }
  }
  printf(“%d\n”,sum);
  return 0;
}
```

The code in Example C above may be stored in a file called opt2.c, for example, and compiled as follows: xlc-o opt2 opt2.c. Since the code in Example C is further optimized, we have the following results which indicate a total execution time of approximately 0.8, reflecting additional time savings of about 0.1 seconds over the 0.9 seconds execution time of the code in Example B.

| runs on a power6 machine: | |
|---|---|
| bash-3.00$ time ./opt2 100000000 10 | |
| 1800000000 | |
| real | 0m0.808s |
| user | 0m0.806s |
| sys | 0m0.002s |
| bash-3.00$ time ./opt2 100000000 10 | |
| 1800000000 | |
| real | 0m0.808s |
| user | 0m0.805s |
| sys | 0m0.002s |

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

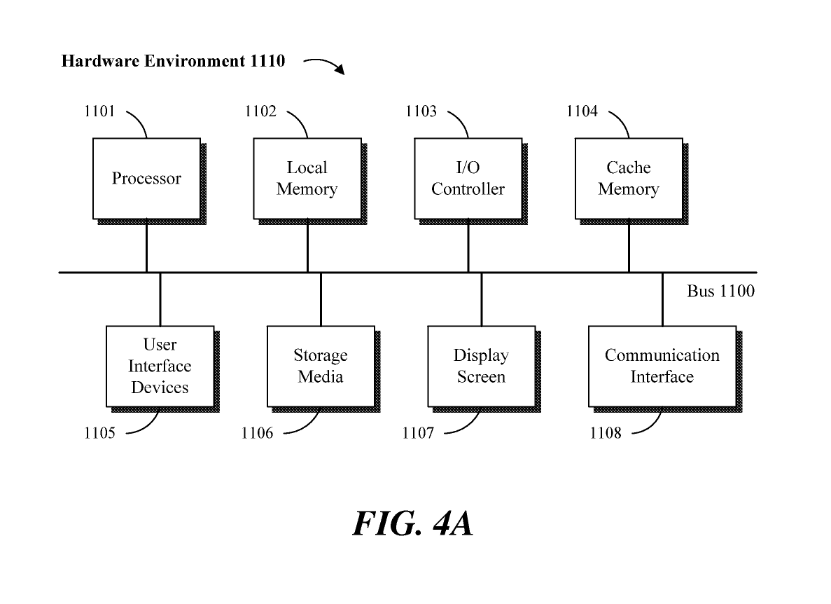

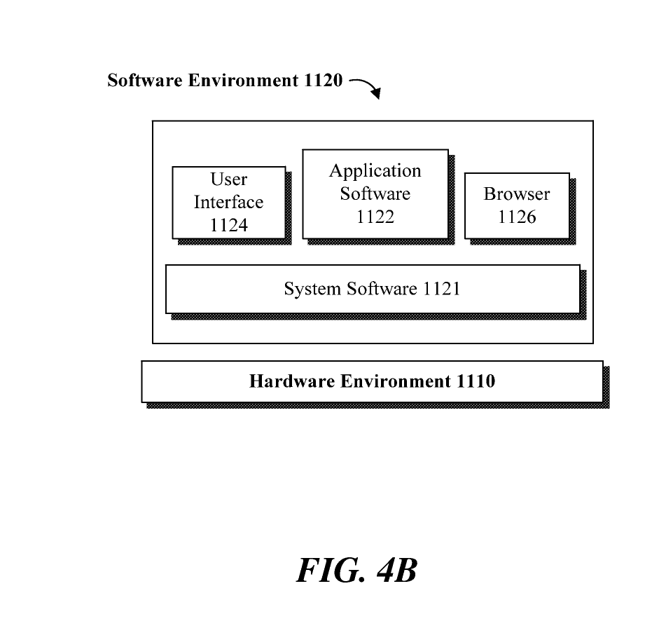

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of computer readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other computer-usable or computer readable media. Within the context of this disclosure, a computer usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-RAY), digital video disk (DVD), high definition video disk (HD-DVD) or Blue-Ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a computer-usable or computer readable storage medium that provides program code for use by, or in connection with, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A code optimization method implemented to operate in a computing environment, the method comprising:
dividing a target code into basic blocks;
analyzing traversed execution paths between the basic blocks during multiple executions of the target code to determine a frequency with which the execution path between two or more basic blocks are traversed; and
determining whether code optimization may be achieved by identifying execution paths that have been traversed subject to one or more threshold levels.

2. The method of claim 1, wherein the basic blocks are representable as nodes, and a path of execution from a first basic block to a second basic block is representable by an edge starting from a first node and ending at a second node.

3. The method of claim 2, wherein the determining is further performed based on a logical conclusion derived from realization that an edge is traversed subject to said threshold levels in relation to value of at least one variable meeting a first condition.

4. The method of claim 3, wherein the analyzing is performed based on different values assigned to one or more variables during the multiple executions of the target code.

5. The method of claim 4, further comprising optimizing the target code by way of implementing a specialized function to replace a function in at least a basic block associated with the one or more identified edges.

6. The method of claim 5, wherein the optimization is performed based on collecting value profiles for the one or more variables upon which conditional branching in a basic block depends.

7. The method of claim 6, wherein the value profiles for the one or more variables are collected by profiling conditions that lead to frequently executed edges in the target code.

8. The method of claim 7, wherein the optimization is performed by using a specialized function when at least one condition is met.

9. The method of claim 8, wherein the specialized function is used, in response to determining that conditional branching in a basic block depends on value of one or more target variables used in a function in the basic block.

10. The method of claim 9, wherein most common value assigned to at least one target variable used in the function is determined in order to optimize the target code using the specialized function that is implemented based on said most common value.

11. A code optimization system comprising:
a logic unit for dividing a target code into basic blocks;
a logic unit for analyzing traversed execution paths between the basic blocks during multiple executions of the target code to determine a frequency with which the execution path between two or more basic blocks are traversed; and
a logic unit for determining whether code optimization may be achieved by identifying execution paths that have been traversed subject to one or more threshold levels.

12. The system of claim 11, wherein the basic blocks are representable as nodes, and a path of execution from a first basic block to a second basic block is representable by an edge starting from a first node and ending at a second node.

13. The system of claim 12, wherein the determining is further performed based on a logical conclusion derived from realization that an edge is traversed subject to said threshold levels in relation to value of at least one variable meeting a first condition.

14. The system of claim 13, wherein the analyzing is performed based on different values assigned to one or more variables during the multiple executions of the target code.

15. A computer program product comprising a computer readable storage medium having a computer readable program, wherein the computer readable program when executed on a computer causes the computer to:
divide a target code into basic blocks;
analyze traversed execution paths between the basic blocks during multiple executions of the target code to determine a frequency with which the execution path between two or more basic blocks are traversed; and
determine whether code optimization may be achieved by identifying execution paths that have been traversed subject to one or more threshold levels.

16. The computer program product of claim 15, wherein the basic blocks are representable as nodes, and a path of execution from a first basic block to a second basic block is representable by an edge starting from a first node and ending at a second node.

17. The computer program product of claim 16, wherein the determining is further performed based on a logical conclusion derived from realization that an edge is traversed subject to said threshold levels in relation to value of at least one variable meeting a first condition.

18. The computer program product of claim 17, wherein the analyzing is performed based on different values assigned to one or more variables during the multiple executions of the target code.

19. The computer program product of claim 18, wherein the analyzing is performed based on different values assigned to one or more variables during the multiple executions of the target code.

20. The computer program product of claim 19, wherein the target code is optimized by way of implementing a specialized function to replace a function in at least a basic block associated with the one or more identified edges.
